(19) United States
(12) Patent Application Publication
(10) Pub. No.: US 2005/0036409 A1
(43) Pub. Date: Feb. 17, 2005

(54) Method and apparatus for correcting tilt in disc drive

(75) Inventors: Dong-ki Hong, Gyeonggi-do (KR); Jee-hyung Park, Seoul (KR); Soo-yul Jung, Gyeonnggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd, Suwon City (KR)

(21) Appl. No.: 10/642,674

(22) Filed: Aug. 19, 2003

(30) Foreign Application Priority Data
Aug. 17, 2003 (KR) 2002-48705

(51) Int. Cl. G11B 7/095

(52) U.S. Cl. 369/44.32; 369/53.19

(57) ABSTRACT

A method and apparatus for correcting a tilt without repeatedly calculating a tilt angle with respect to a corresponding recording or reproducing sector, by managing the tilt angle detected with respect to each recording sector of a disc in a disc drive. If a tilt of a disc mounted in the disc drive is detected, a memory is searched for a tilt angle for a sector of the disc in which the tilt is detected. If no tilt angle is found in the memory, a tilt angle is calculated for the sector based on the detected tilt of the disc, the tilt of the disc is corrected, and the calculated tilt angle is stored in the memory to be used for the sector. If a tilt angle is found in the memory, the tilt of the sector is corrected using the found tilt angle.

### CROSS-REFERENCE TO RELATED APPLICATION

This application is based on Korean Patent Application No. 2002-48705, filed on Aug. 17, 2002, in the Korean Intellectual Property Office, the disclosure of which is incorporated herein by reference.

### BACKGROUND OF THE INVENTION

1. Field of the Invention

The present invention relates to a method and apparatus for correcting a tilt in a disc drive, and more particularly, to a method and apparatus for correcting a tilt without repeatedly detecting a tilt angle of a disc.

2. Description of the Related Art

Tilting refers to the inclination of a recording or reproducing surface of a disc in a disc drive. Tilting may occur due to distortion or deformation of the disc. In a case where the disc is not tilted, a laser light beam emitted from an optical pickup is nearly perpendicularly radiated onto the recording or reproducing surface of the disc. On the contrary, in an event that the disc is tilted, an optical spot formed on the recording or reproducing surface of the disc by the laser light beam emitted from the optical pickup is distorted, thereby reducing the radiation intensity of the laser light beam per unit area of the recording surface of the disc. Due to this, the geometry of the pits is effectively varied from what is desired, which results in jitter during reproducing of information.

Accordingly, an existing disc drive detects a tilt of a disc using a tilt sensor included in an optical pickup or a laser light beam reflected from a recording or reproducing surface of the disc. When the tilt of the disc is detected, a tilt angle of the disc to be corrected is calculated according to the detected tilt. A method of correcting a tilt by inclining the existing optical pickup, or an objective lens in the existing optical pickup, according to the calculated tilt angle has been proposed.

Besides this method, other methods of correcting a tilt have been proposed. However, in the proposed methods, a tilt correcting operation is performed only one time or whenever the tilt is detected. In the former case, since the tilt correcting operation is performed only one time, although the tilt of a disc can gradually change from the inner perimeter toward the outer perimeter, an efficiency of correcting the tilt degrades. In the latter case, when data is repeatedly reproduced from a disc that is tilted, a tilt correcting operation is repeatedly performed in the same sector of the disc. Therefore, the tilt correcting operation tends to be inefficiently performed.

### SUMMARY OF THE INVENTION

Accordingly, it is an aspect of the present invention to provide a method and apparatus for correcting a tilt without repeatedly calculating a tilt angle with respect to a corresponding recording or reproducing sector, by managing the tilt angle detected with respect to each recording sector of a disc in a disc drive.

It is another aspect of the present invention to provide a method and apparatus for correcting a tilt by managing a tilt angle detected with respect to each recording or reproducing sector of a disc according to the position information of an optical pickup detected using the number of pulses necessary for driving a slide transfer motor in a disc drive.

According to another aspect of the present invention, there is provided a method of correcting a tilt in a disc drive. If a tilt of a disc mounted in the disc drive is detected, a memory in the disc drive is searched for a tilt angle for a recording or reproducing sector of the disc in which the tilt is detected. If no tilt angle is found in the memory, a tilt angle is calculated for the recording or reproducing sector based on the detected tilt of the disc. The tilt of the disc is corrected, and the calculated tilt angle is stored in the memory so that the calculated tilt angle is used for the recording or reproducing sector. If a tilt angle is found in the memory, the tilt of the recording or reproducing sector is corrected using the found tilt angle.

According to an aspect of the present invention, the recording or reproducing sector of the disc is based on information on the position of the pickup based on the number of pulses for driving a motor for controlling movement of the pickup in the disc drive.

According to another aspect of the present invention, there is provided an apparatus for correcting a tilt in a disc drive. The apparatus includes a pickup, a tilt detector, a motor, a memory, and a controller. The pickup radiates light onto a disc placed in the disc drive. The tilt detector detects a tilt of the disc using the pickup. The motor drives the pickup to correct the tilt of the disc. The memory stores a tilt angle for each recording or reproducing sector of the disc. If a tilt of the disc is detected, the controller searches the memory for a tilt angle for a recording or reproducing sector of the disc wherein the pickup is currently positioned, and controls driving of the motor using the searched tilt angle.

According to an aspect of the present invention, it is preferable that if the tilt angle is not searched in the memory, a controller calculates a tilt angle for the recording or reproducing sector of the disc based on the tilt of the disc, corrects the tilt of the disc using the calculated tilt angle, and stores the calculated tilt angle in the memory.

According to still another aspect of the present invention, there is also provided an apparatus for correcting a tilt in a disc drive. The apparatus includes a pickup, a pickup moving unit, a tilt detector, a first motor, a memory, and a controller. The pickup radiates light onto a disc mounted in the disc drive. The pickup moving unit moves the pickup in a radial direction of the disc. The tilt detector detects the tilt of the disc using the pickup. The first motor drives the pickup to correct the tilt of the disc. The memory stores a tilt angle for each recording or reproducing sector of the disc based on the position information of the pickup and the position information of the pickup. The controller detects the position information of the pickup based on the number of pulses for driving a second motor in the pickup moving unit and stores the position information in the memory, and if the tilt of the disc is detected by the tilt detector, searches the memory for a tilt angle for a sector of the disc from which the tilt is detected and controls driving of the first motor using the searched tilt angle.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings in which:

FIG. 1 is a block diagram of a disc drive having a tilt correcting apparatus according to an embodiment of the present invention;

FIG. 2 is a flowchart for explaining a process of storing the position information of a pickup in a tilt correcting method according to an embodiment of the present invention; and

FIG. 3 is a flowchart for explaining a method of correcting a tilt according to an embodiment of the present invention.

### DETAILED DESCRIPTION OF THE INVENTION

Reference will now be made in detail to the present preferred, examples of which are illustrated in the accompanying drawings, wherein like reference numerals refer to like elements throughout.

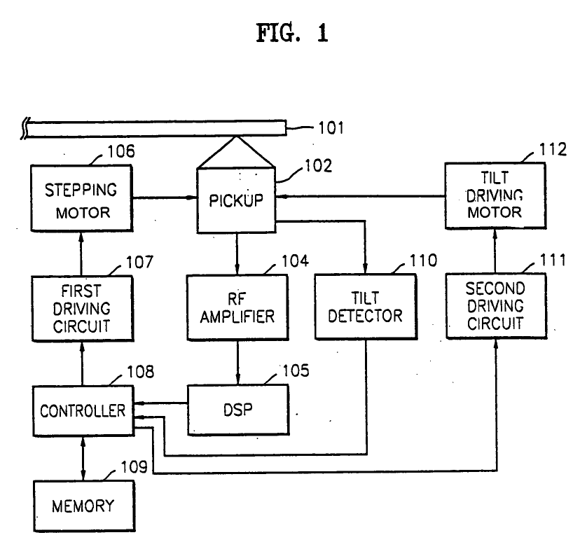

FIG. 1 is a block diagram of a disc drive 100 having a tilt correcting apparatus according to an embodiment of the present invention. Referring to FIG. 1, the disc drive includes a disc 101, a pickup 102, an RF amplifier 104, a digital signal processor (DSP) 105, a stepping motor 106, a first driving circuit 107, a controller 108, a memory 109, a tilt detector 110, a second driving circuit 111, and a tilt driving motor 112.

The disc 101 may be a CD, a DVD, or an optical medium, on or from which, information can be recorded or reproduced.

The pickup 102 radiates a light beam onto the disc 101 to record data thereon, or reproduce data therefrom. In an embodiment of the present invention, the pickup 102 may include a tilt sensor.

The RF amplifier 104 amplifies an RF signal output from the pickup 102 to a predetermined level. The amplified RF signal is transmitted to the DSP 105. The DSP 105 converts the amplified RF signal into a digital signal and transmits the digital signal to the controller 108.

The controller 108 determines the number of pulses necessary for driving the stepping motor 106 according to the digital signal and a current operation mode of the disc drive. The controller 108 outputs a drive control signal based on the determined number of driving pulses to the first driving circuit 107.

The controller 108 reads information on the number of pulses necessary for driving the stepping motor 106 corresponding to the position information of the pickup 102 stored in the memory 109. For example, the position information of the pickup 102 is the previous position of the pickup 102.

The controller 108 calculates the number of driving pulses to be generated by the first driving circuit 107 and the number of driving pulses read from the memory 109. In other words, when calculating the pulses necessary for driving the stepping motor 106 so that the pickup 102 moves toward the outermost track of the disc 101, the controller 108 adds the number of driving pulses to be presently generated to the number of driving pulses read from the memory 109. On the contrary, when calculating the pulses necessary for driving the stepping motor 106 so that the pickup 102 moves toward the innermost track of the disc 101, the controller 108 subtracts the number of driving pulses to be presently generated from the number of driving pulses read from the memory 109. The addition or subtraction result is stored, as information on the current position of the pickup 102, in the memory 109. As a result, information on the position of the pickup 102 in the memory 109 is updated. In other words, the controller 108 updates the position information of the pickup 102, stored in the memory 109, based on the number of pulses necessary for driving the stepping motor 106, the pulses being generated in correspondence to the moving distance of the pickup 102.

The first driving circuit 107 provides the stepping motor 106 with the corresponding number of driving pulses according to the drive control signal transmitted from the controller 108.

The stepping motor 106 is a slide transfer motor for actuating the pickup 102. The stepping motor 106 is driven by the driving pulses provided by the first driving circuit 107 to move the pickup 102. Thus, the pickup 102 moves in a radial or tracking direction of the disc 101. Here, the pickup 102 and the stepping motor 106 may be connected using a lead screw (not shown).

When the tilt detector 110 detects a tilt of the disc 101, the controller 108 starts a tilt correction on a corresponding recording or reproducing sector of the disc 101 from which the tilt was detected. In a case where the pickup 102 includes a tilt sensor, the tilt detector 110 detects the tilt of the disc 101 using a signal output from the tilt sensor. Alternatively, the tilt detector 110 may detect the tilt of the disc 101 based on the amount of light reflected from the disc 101.

The controller 108 searches for a tilt angle based on the recording or reproducing sector of the disc 101 in the memory 109. The tilt angle corresponds to the correction amount of the tilt. The recording or reproducing sector of the disc 101 is based on the position information of the pickup 102 based on the number of pulses for driving the stepping motor 106. In other words, the controller 108 searches for a tilt angle for the recording or reproducing sector in the memory 109 based on the position information of the pickup 102 corresponding to that recording or reproducing sector.

If a tilt angle is found in the memory 109, the recording or reproducing sector of the disc 101 becomes a sector in which a tilt is corrected at least one time. Thus, the controller 108 does not repeatedly calculate the tilt angle. The controller 108 corrects the tilt of the disc 101 using the tilt angle detected from the memory 109.

However, if the tilt angle is not found in the memory 109, the recording or reproducing sector of the disc 101 becomes a sector in which a tilt is not corrected at all. Thus, the controller 108 calculates a tilt angle based on the detected tilt. Calculating the tilt angle may be performed using one of the existing methods.

When the tilt angle is calculated, the controller 108 outputs a control signal necessary for correcting the tilt of the disc 101 based on the calculated tilt angle to the second driving circuit 111. When the second driving circuit 111 receives the control signal from the controller 108, the second driving circuit 111 drives the tilt driving motor 112 so that the pickup 102 moves according to the tilt angle of the disc 101. As a result, the tilt driving motor 112 controls a focusing position of the pickup 102.

The controller 108 stores the calculated tilt angle in the memory 109. Here, the controller 108 stores the calculated tilt angle using the position information of the pickup 102 so that the tilt angle for each recording or reproducing sector of the disc 101 is searched for. The memory 109 stores the position information of the pickup 102 and the tilt angle corresponding thereto. The position Information of the pickup 102 is expressed by the number of pulses necessary for driving the stepping motor 106.

Correcting a tilt of the disc 101 by detecting the tilt of the disc 101 is performed in all sectors of the disc 101.

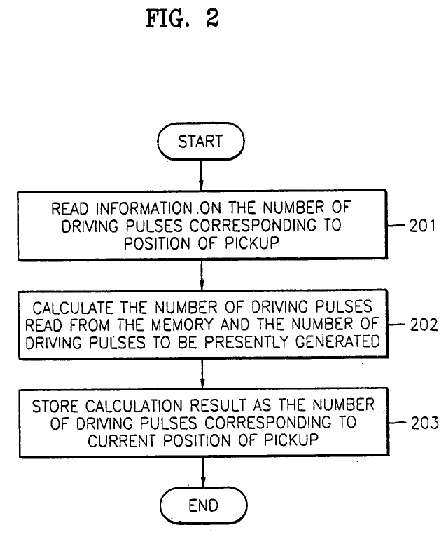

FIG. 2 is a flowchart for explaining a process of storing position information of a pickup in a tilt-correcting method according to an embodiment of the present invention.

To determine the number of pulses necessary for driving a motor e.g., the stepping motor 106, in operation 201 information is read by the controller 108 on the number of driving pulses corresponding to the position of the pickup 102 from the memory 109. Here, information on the number of driving pulses read from the memory 109 corresponds to the previous position of the pickup 102.

In operation 202, the number of driving pulses to be generated by the first driving circuit 107, are calculated by controller 108 based on the number of driving pulses read from the memory 109. In other words, in an example case where the pickup 102 moves toward the outermost track of the disc 101, the controller 108 adds the number of driving pulses to be generated by the first driving circuit 107 to the number of driving pulses read from the memory 109. On the contrary, in an event that the pickup 102 moves toward the innermost track of the disc 101, the controller 108 subtracts the number of driving pulses to be generated by the first driving circuit 107 from the number of driving pulses read from the memory 109.

In operation 203, calculation results are stored by the controller 108 as the number of driving pulses corresponding to information on the current position of the pickup 102 in the memory 109.

Operations 201, 202, and 203 are repeated whenever the first driving circuit 107 generates pulses for driving the stepping motor 106 as the pickup 102 moves.

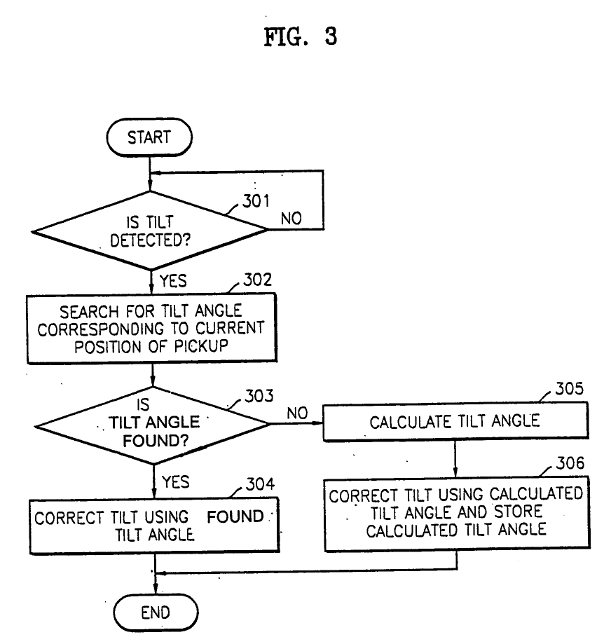

FIG. 3 is a flowchart for explaining a method of correcting a tilt according to an embodiment of the present invention.

In operation 301, the tilt of the disc 101 is detected. In operation 302, a tilt angle for a recording or reproducing sector of the disc 101 in which the pickup 102 is currently positioned is searched for in the memory 109 by controller 108.

In operation 303, it is determined whether the tilt angle has been found in the memory 109. If the tilt angle has been found in the memory 109 in operation 303, the recording or reproducing sector of the disc 101 is regarded as already being corrected for a tilt at least one time. Thus, in operation 304, the tilt of the disc 101 is corrected using the found tilt angle.

If the tilt angle has not been found in the memory 109 in operation 303, it is determined by controller 108 that the recording or reproducing sector of the disc 101 is not corrected for a tilt at all. Thus, in operation 305, the tilt angle is calculated by controller 108 using the detected tilt.

In operation 306, the controller 108 corrects the tilt of the disc 101 using the calculated tilt angle while storing the calculated tilt angle in the memory 109, so that the calculated tilt angle is used when correcting the tilt of a corresponding recording or reproducing sector of the disc 101.

The tilt angle values for each recording or reproducing sector of the disc 101 stored in the memory 109 may be cleared by the controller 108 when a new disc is placed in the disc drive.

According to other aspects of the invention, the controller unit 108 or other component is a computer implementing the method shown in FIG. 2 using data encoded on a computer readable medium.

As described above, according to the present invention, a tilt angle detected for each of a recording and reproducing sector of a disc placed in a disc drive can be stored and used according to a position of a pickup. As such, there is no need for repeatedly detecting the tilt angle from the same recording or reproducing sector of the same disc, so that a tilt correction of the disc drive can be effectively performed.

Although a few preferred embodiments of the present invention have been shown and described, it would be appreciated by those skilled in the art that changes may be made in these embodiments without departing from the principles and of the invention, the spirit and scope of which is defined in the claims and their equivalents.

1. A method of correcting a tilt in a disc drive, the method comprising:
detecting a tilt of a disc loaded in the disc drive;
searching a memory in the disc drive for a tilt angle for a recording or reproducing sector of the disc in which the tilt is detected;
calculating a tilt angle for the recording or reproducing sector based on the detected tilt of the disc if no tilt angle is found in the memory;
correcting the tilt of the disc; and
storing the calculated tilt angle in the memory so that the calculated tilt angle is used for the recording or reproducing sector,
wherein if a tilt angle is found in the memory, the tilt of the disc is corrected using the found tilt angle, and if the tilt angle is not found in the memory, the tilt of the disc is corrected using the calculated tilt angle.

2. The method of claim 1, wherein the recording or reproducing sector of the disc is based on information on the position of a pickup based on the number of pulses for driving a motor for controlling movement of the pickup in the disc drive.

3. An apparatus for correcting a tilt of a disc placed in a disc drive, the apparatus comprising:
a pickup that radiates light onto the disc;
a tilt detector that detects a tilt of the disc using the pickup;
a motor that drives the pickup to correct the tilt of the disc;
a memory that stores a tilt angle for each of the plurality of recording and reproducing sectors of the disc; and
a controller that, if the tilt of the disc is detected, searches the memory for the tilt angle for the recording or reproducing sector of the disc wherein the pickup is currently positioned, and controls driving of the motor using the searched tilt angle.

4. The apparatus of claim 3, wherein if the tilt angle is not found in the memory, the controller calculates the tilt angle for the recording or reproducing sector of the disc wherein the pickup is currently positioned based on the tilt of the disc, corrects the tilt of the disc using the calculated tilt angle, and stores the calculated tilt angle in the memory.

5. An apparatus for correcting a tilt of a disc placed in a disc drive, the apparatus comprising:
a pickup that radiates light onto the disc;
a pickup moving unit that moves the pickup in a radial direction of the disc;
a tilt detector that detects the tilt of the disc using the pickup;
a first motor that drives the pickup to correct the tilt of the disc;
a memory that stores a tilt angle for each recording or reproducing sector of the disc based on the position information of the pickup and the position information of the pickup; and
a controller that detects the position information of the pickup based on the number of pulses for driving a second motor in the pickup moving unit and stores the position information in the memory, and if the tilt of the disc is detected by the tilt detector, searches the memory for a tilt angle for a sector of the disc from which the tilt is detected and controls driving of the first motor using the searched tilt angle.

6. The apparatus of claim 5, wherein if the tilt angle is not found in the memory, the controller calculates a tilt angle for the sector of the disc from which the tilt is detected, corrects the tilt of the disc, and stores the calculated tilt angle in the memory.

7. A computer readable medium encoded with processing instructions for implementing a method of correcting a tilt in a disc drive, the method comprising:
detecting a tilt of a disc loaded in the disc drive;
searching a memory in the disc drive for a tilt angle for a recording or reproducing sector of the disc in which the tilt is detected;
calculating a tilt angle for the recording or reproducing sector based on the detected tilt of the disc if no tilt angle is found in the memory;
correcting the tilt of the disc; and
storing the calculated tilt angle in the memory so that the calculated tilt angle is used for the recording or reproducing sector,
wherein if the tilt angle is found in the memory, the tilt of the disc is corrected using the found tilt angle, and if the tilt angle is not found in the memory, the tilt of the disc is corrected using the calculated tilt angle.

8. The computer readable medium of claim 7, wherein the recording or reproducing sector of the disc is based on information on the position of a pickup based on the number of pulses for driving a motor for controlling movement of the pickup in the disc drive.

9. A method for driving a stepping motor, comprising:
reading information on a number of required driving pulses corresponding to a position of a pickup;
calculating a number of driving pulses to be generated based on the number of driving pulses required and a number of driving pulses previously generated;
generating the calculated number of driving pulses; and
storing the calculated number of driving pulses corresponding to the position of pickup.

10. The method according to claim 9, wherein the position of the pickup corresponds to one of a plurality of recording and reproducing sectors of a disc.

11. The method according to claim 10, wherein the stepping motor is used to correct a tilt of the disc.

12. A computer readable medium encoded with processing instructions for implementing a method for driving a stepping motor, the method comprising:
reading information on a number of required driving pulses corresponding to a position of a pickup;
calculating a number of driving pulses to be generated based on the number of driving pulses required and a number of driving pulses previously generated;
generating the calculated number of driving pulses; and
storing the calculated number of driving pulses corresponding to the position of pickup.

13. The computer readable medium as in claim 12, wherein the position of the pickup corresponds to one of a plurality of recording and reproducing sectors of a disc.

14. The computer readable medium as in claim 13, wherein the stepping motor is used to correct a tilt of the disc.
